(19) United States
(12) Patent Application Publication
(10) Pub. No.: US 2025/0292000 A1
(43) Pub. Date: Sep. 18, 2025

(54) DECOMPOSING COMPOSITE DOCUMENTS

(71) Applicant: INTERNATIONAL BUSINESS MACHINES CORPORATION, ARMONK, NY (US)

(72) Inventors: Rodrigo Reis Alves, Campinas (BR); Angelo Moore, Dunboyne (IE); Daniela Arrigoni, Seregno (IT); Valdir Salustino Guimaraes, Americana (BR); Vasanthi M. Gopal, Plainsboro, NY (US)

(21) Appl. No.: 18/604,746

(22) Filed: Mar. 14, 2024

(51) Int. Cl. G06F 40/114; G06F 18/232

(52) U.S. Cl. CPC G06F 40/114; G06F 18/232

(57) ABSTRACT

An embodiment for decomposing composite scanned documents. The embodiment may detect a target composite scanned document. The embodiment may extract, for sequential pages of the target composite scanned document, a series of document features. The embodiment may iteratively generate a series of sub-documents by iteratively adding a next page from the target composite scanned document to a series of one or more pages preceding the added next page. The embodiment may generate vector representations for each of the iteratively generated series of sub-documents, where each of the generated vector representations is based on the extracted series of document features. The embodiment may calculate similarity scores by comparing the generated vector representations with a knowledgebase of document vectors. The embodiment may cluster the sequential pages of the target composite scanned document based on the calculated similarity scores. The embodiment may output separate files including the clustered sequential pages.

### BACKGROUND

The present application relates generally to computer processing, and more particularly, to decomposing composite scanned documents.

In many business processes, such as contract negotiations, documents may be scanned and merged into single digital documents for storage and ease of distribution. The content of digital documents is often subject to various types of automatic analyses or post-processing. To secure competitive advantages, businesses strive to optimize their flexibility and efficiency with respect to performing analyses of digital documents.

### SUMMARY

According to one embodiment, a method, computer system, and computer program product for decomposing composite scanned documents is provided. The embodiment may include detecting a target composite scanned document. The embodiment may further include extracting, for sequential pages of the target composite scanned document, a series of document features. The embodiment may also include iteratively generating a series of sub-documents by iteratively adding a next page from the target composite scanned document to a series of one or more pages preceding the added next page. The embodiment may further include generating vector representations for each of the iteratively generated series of sub-documents, where each of the generated vector representations is based on the extracted series of document features of the sequential pages contained in a corresponding respective sub-document. The embodiment may further include calculating similarity scores by comparing the generated vector representations with a knowledgebase of document vectors. The embodiment may also include clustering the sequential pages of the target composite scanned document based on the calculated similarity scores. The embodiment may further include outputting separate files including the clustered sequential pages.

### BRIEF DESCRIPTION OF THE SEVERAL VIEWS OF THE DRAWINGS

These and other objects, features and advantages of the present disclosure will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment;

FIG. 2 illustrates an operational flowchart for an exemplary process of decomposing composite scanned documents according to at least one embodiment;

FIG. 3 illustrates exemplary system architecture for performing an illustrative process of decomposing composite scanned documents according to at least one embodiment;

FIG. 4 illustrates a block diagram of an exemplary process of decomposing a target composite scanned document to generate clusters of sequential pages in accordance with at least one embodiment;

FIG. 5 depicts an exemplary plot of calculated similarity scores that may be leveraged to cluster sequential pages for decomposing a target composite scanned document according to at least one embodiment;

FIG. 6 illustrates a block diagram of an exemplary process of generating groups of pages by leveraging similarity scores between vector representations of adjacent sequential pages from a target composite scanned document according to at least one embodiment; and

FIG. 7 illustrates a block diagram of an exemplary process of decomposing composite scanned documents according to at least one embodiment.

### DETAILED DESCRIPTION

Detailed embodiments of the claimed structures and methods are disclosed herein; however, it can be understood that the disclosed embodiments are merely illustrative of the claimed structures and methods that may be embodied in various forms. The present disclosure may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present application relate generally to decomposing composite scanned documents. The following described exemplary embodiments provide a system, method, and program product to, among other things, generate, for a target composite scanned document, vector representations of sub-documents including sequential pages of the target composite scanned document and their corresponding extracted document features. The vector representations of the sub-documents may be compared to a knowledge base of document vectors to calculate similarity scores usable by described embodiments to cluster the sequential pages, and output the clusters of sequential pages as one or more separate files, thereby decomposing the target composite scanned document.

As previously described, in many business processes, such as contract negotiations, documents may be scanned and merged into single digital documents for storage and ease of distribution. The content of digital documents is often subject to various types of automatic analyses or post-processing. To secure competitive advantages, businesses strive to optimize their flexibility and efficiency with respect to performing analyses of digital documents.

However, the practice of scanning and merging component documents into singular digital documents can present challenges for various automated contract analysis systems relating to strained memory and CPU or GPU usage, increased process times, duplication difficulties, challenges with handling multiple languages between documents, or various other document-specific analyses that may be invalidated or made more difficult by document merging. Thus, automated systems for detecting and decomposing merged documents as a pre-processing step for enabling and facilitating various subsequent automatic analyses would be advantageous for a variety of business processes.

Accordingly, a method, computer system, and computer program product for decomposing composite scanned documents is provided. The method, system, and computer program product may detect a target composite scanned document. The method, system, computer program product may extract, for sequential pages of the target composite scanned document, a series of document features. The method, system, computer program product may then iteratively generate a series of sub-documents by iteratively adding a next page from the target composite scanned document to a series of one or more pages preceding the added next page. The method, system, computer program product may generate vector representations for each of the iteratively generated series of sub-documents, where each of the generated vector representations is based on the extracted series of document features of the sequential pages contained in a corresponding respective sub-document. The method, system, computer program product may then calculate similarity scores by comparing the generated vector representations with a knowledgebase of document vectors. The method, system, computer program product may then cluster the sequential pages of the target composite scanned document based on the calculated similarity scores. Thereafter, the method, system, computer program product may output separate files including the clustered sequential pages. In turn, the method, system, computer program product has provided for improved decomposing of composite scanned documents. Described embodiments extract document features from sequential pages in a target composite scanned document to generate vector representations of a series of sub-documents including increasing numbers of sequential pages from the target composite scanned document. Described embodiments may then compare the vector representations of the respective sub-documents to a knowledge base of document vectors for an applicable domain with which the target composite scanned document is associated to calculate similarity scores. Described embodiments may then cluster the sequential pages based on the calculated similarity scores, and allow for a target composite scanned document to be decomposed and output as one or more separate files that are likely to correspond to the individual component documents from which the target composite scanned document was derived. Described embodiments may identify anchor pages corresponding to local maximum values for the calculated similarity scores to determine which of the sequential pages may correspond to a new cluster of pages corresponding to a separate component document. Described embodiments thus provide automated methods for detecting and decomposing merged documents that may be leveraged as an effective preprocessing step for enabling and facilitating automatic analyses would be advantageous for a variety of business processes.

The present invention may be a system, a method, and/or a computer program product at any possible technical detail level of integration. The computer program product may include a computer readable storage medium (or media) having computer readable program instructions thereon for causing a processor to carry out aspects of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

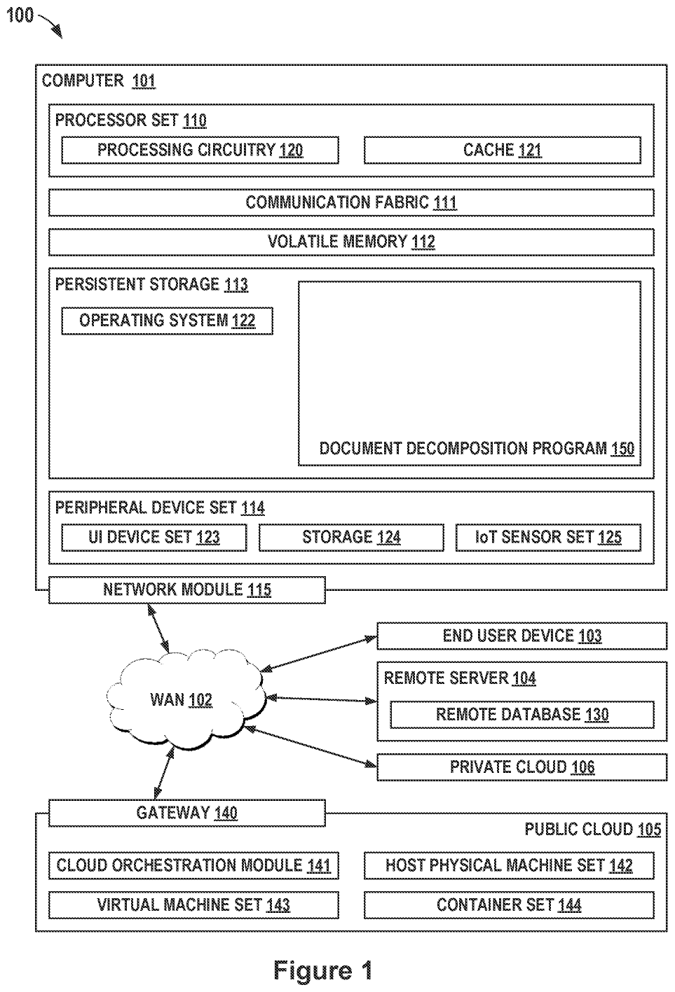

Referring now to FIG. 1, computing environment 100 contains an example of an environment for the execution of at least some of the computer code involved in performing the inventive methods, such as document decomposition program/code 150. In addition to document decomposition code 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and document decomposition code 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in document decomposition code 150 in persistent storage 113.

COMMUNICATION FABRIC 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in document decomposition program 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. According to one embodiment where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

According to the present embodiment, the document decomposition program 150 may be a program capable of detecting a target composite scanned document. The document decomposition program 150 may then extract, for sequential pages of the target composite scanned document, a series of document features. Next, the document decomposition program 150 may iteratively generate a series of sub-documents by iteratively adding a next page from the target composite scanned document to a series of one or more pages preceding the added next page. The document decomposition program 150 may then generate vector representations for each of the iteratively generated series of sub-documents, where each of the generated vector representations is based on the extracted series of document features of the sequential pages contained in a corresponding respective sub-document. Next, the document decomposition program 150 may calculate similarity scores by comparing the generated vector representations with a knowledgebase of document vectors. Then, the document decomposition program 150 may cluster the sequential pages of the target composite scanned document based on the calculated similarity scores. Thereafter, the document decomposition program 150 may output separate files including the clustered sequential pages. In turn, the described method, system, computer program product has provided for improved decomposing of composite scanned documents. Described embodiments extract document features from sequential pages in a target composite scanned document to generate vector representations of a series of sub-documents including increasing numbers of sequential pages from the target composite scanned document. Described embodiments may then compare the vector representations of the respective sub-documents to a knowledge base of document vectors for an applicable domain with which the target composite scanned document is associated to calculate similarity scores. Described embodiments may then cluster the sequential pages based on the calculated similarity scores, and allow for a target composite scanned document to be decomposed and output as one or more separate files that are likely to correspond to the individual component documents from which the target composite scanned document was derived. Described embodiments may identify anchor pages corresponding to local maximum values for the calculated similarity scores to determine which of the sequential pages may correspond to a new cluster of pages corresponding to a separate component document. Described embodiments thus provide automated methods for detecting and decomposing merged documents that may be leveraged as an effective preprocessing step for enabling and facilitating automatic analyses would be advantageous for a variety of business processes.

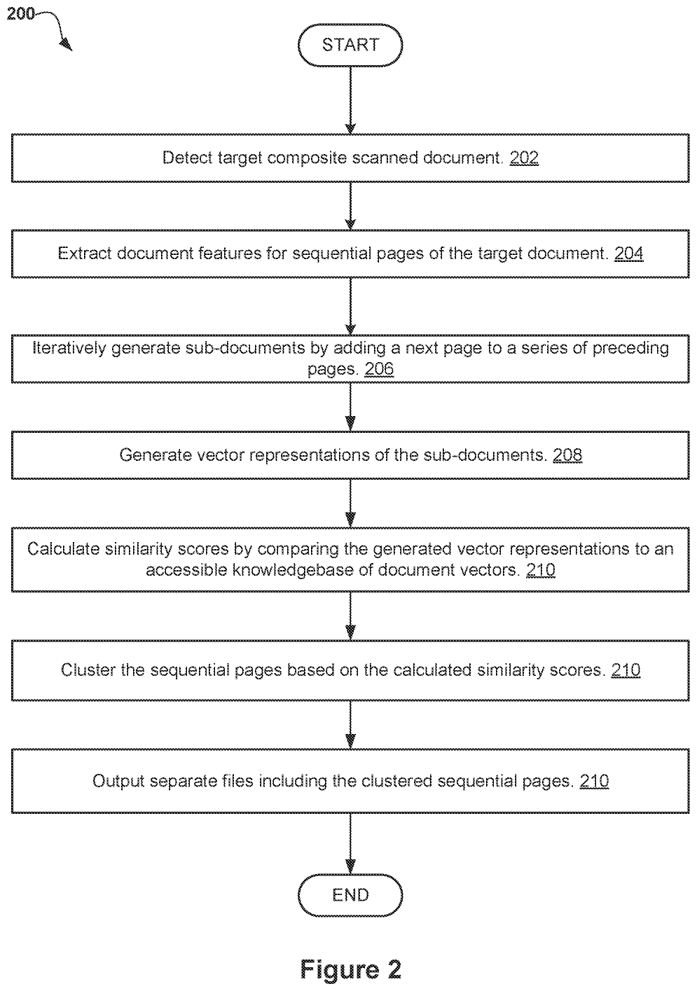

Referring now to FIG. 2, an operational flowchart for an illustrative process 200 of decomposing composite scanned documents according to at least one embodiment is provided.

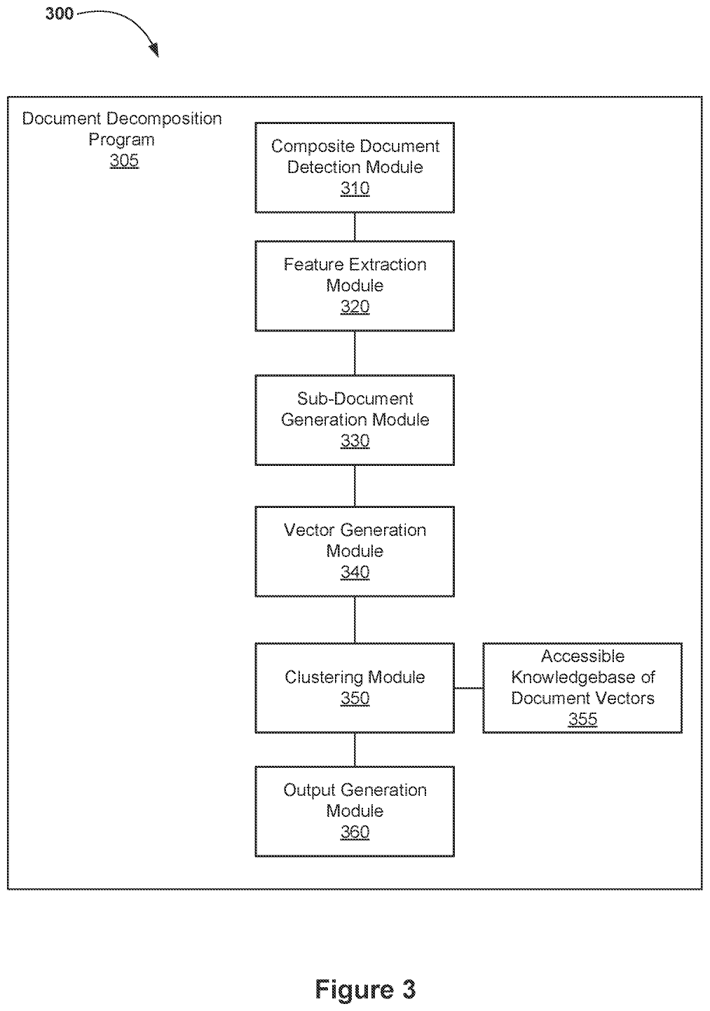

FIG. 3 illustrates exemplary system architecture 300 for performing an illustrative process of decomposing composite scanned documents according to at least one embodiment. An exemplary document decomposition program 150 may include exemplary system architecture 300 having a composite document detection module 310 for detecting a target composite scanned document, a feature extraction module 320 for extracting document features from sequential pages of a target composite document, a sub-document generation module 330 for generating sub-documents by iteratively adding a next sequential page to a previously generated sub-document, a vector generation module 340 for generating vector representations of the sub-documents, a clustering module 350 for calculating similarity scores between the vector representations of the sub-documents and an accessible knowledge base 355 of document vectors and generating respective clusters of sequential pages based on the calculated similarity scores, and an output generation module 360 for outputting separate files based on the generated respective clusters of sequential pages (sometimes referred to as groups of pages). Exemplary system architecture 300 and its components will be referenced throughout the description of the steps that make up illustrative process 200 discussed below.

At 202, the document decomposition program 150 may detect a target composite scanned document. In the context of this disclosure, a target composite scanned document may be any digital document that is composed of multiple individual component documents. The individual component documents may be in any known format and may include any known natural language therein. According to one embodiment, the target scanned document typically is of a singular known format, including converted versions of individual component documents as needed. According to one embodiment, the document decomposition program 150 may be implemented as a part of a standalone tool, application, or as a part of a workflow suitable for a desired environment. In alternative embodiments, it is envisioned that the document decomposition program 150 may be implemented as part of an extension or plugin for an application capable of opening or otherwise interacting with the target composite scanned document.

According to one embodiment, at step 202, an exemplary composite document detection module 310, as shown in FIG. 3, of the document decomposition program 150 may detect a target composite scanned document by any suitable means. For example, in some embodiments, the document decomposition program 150 may detect a target scanned document that has been selected, imported, or otherwise sent by a given user that is interacting with a tool or workflow employing the document decomposition program 150. According to another embodiment, the document decomposition program 150 may automatically detect target composite scanned documents within a series of accessible data associated with a given domain or system directly or indirectly employing the document decomposition program 150. Additional embodiments are envisioned in which an exemplary embodiments of the document decomposition program 150 may be employed to detect and subsequently decompose target composite scanned documents as may be advantageous or useful in various technological environments.

At 204, the document decomposition program 150 may extract, for sequential pages of the target composite scanned document, a series of document features. At this step, an exemplary feature extraction module 320, shown in FIG. 3, may be leveraged by the document decomposition program 150 to extract a series of document features from each sequential page of the target composite scanned document. The extracted series of document features may include, for example, page location and sequences, page structure features (cover page, index, signature page, etc.), page numbers, font used on a page, page textual features including semantic similarity, page layout features and structure of each page (headers, footers, etc.) and any other suitable document features that may be useful for determining similarities between pages of a target composite scanned document. The document decomposition program 150 may extract series of document features from each page using any suitable known natural language processing and feature extraction techniques. For example, at this step, the document decomposition program 150 may extract document features for a first exemplary page ‘P1’ and an adjacent second exemplary page ‘P2’ that were part of an exemplary target composite scanned document ‘T1’. The document decomposition program 150 may extract a series of document features for exemplary pages ‘P1’ and ‘P2’ based on a collection of words contained within each page extracted from an optical character recognition (OCR) analysis including corresponding semantic data, a relevant font used on each page based on an employed font recognition model in a one-hot-encode format, and concatenated vectors generated using text-to-vector models that consider portions of each respective page such as the header, footer, left and right margins, and content, thereby capturing a representation of the layout features of each respective page. Thus, the document decomposition program 150 may leverage a series of known tools and techniques to extract a series of document features for each sequential page of a target composite scanned document that provide a comprehensive representation of various features or characteristics present within each page.

At 206, the document decomposition program 150 may iteratively generate a series of sub-documents by iteratively adding a next page from the target composite scanned document to a series of one or more pages preceding the added next page. For example, an exemplary sub-document generation module 330 (See FIG. 3) of the document decomposition program 150 may generate a first sub-document ‘SD1’ including a first exemplary page ‘P1’. The document decomposition program 150 may then iteratively generate additional sub-documents by adding a second exemplary page ‘P2’ to generate a second sub-document ‘SD2’ including exemplary pages ‘P1’ and ‘P2’, and then add a third exemplary page ‘P3’ to generate a third sub-document ‘D3’ including exemplary pages ‘P1’, ‘P2’ and ‘P3’. The document decomposition program 150 may continue to iteratively generate sub-documents including additional pages until there are no remaining sequential pages from the target composite scanned document that may be added. Thus, the document decomposition program 150 ensures all sequential pages of the target composite scanned document are processed and included within at least one of the generated sub-documents.

At 208, the document decomposition program 150 generate vector representations for each of the iteratively generated series of sub-documents, where each of the generated vector representations is based on the extracted series of document features of the sequential pages contained in a corresponding respective sub-document. According to one embodiment, a vector generation module 340 (as shown in FIG. 3) of the document decomposition program 150 may encode a vector representation for each of the generated sub-documents from step 206. For example, the document decomposition program 150 may generate a first exemplary vector representation ‘V1’ for exemplary sub-document ‘SD1’ which will be representative of the series of document features associated with exemplary page ‘P1’ extracted at 204. The document decomposition program 150 may then generate and a second exemplary vector representation ‘V2’ for exemplary sub-document ‘SD2’ which will be representative of the series of document features associated with exemplary pages ‘P1’ and ‘P2’ extracted at 204, as both pages make up exemplary sub-document ‘SD2’. Exemplary vector generation module 340 of the document decomposition program 150 may utilize any suitable tools for encoding final feature vectors based on the extracted series of document features. The document decomposition program 150 may encode vector representations for each of the generated sub-documents from step 206.

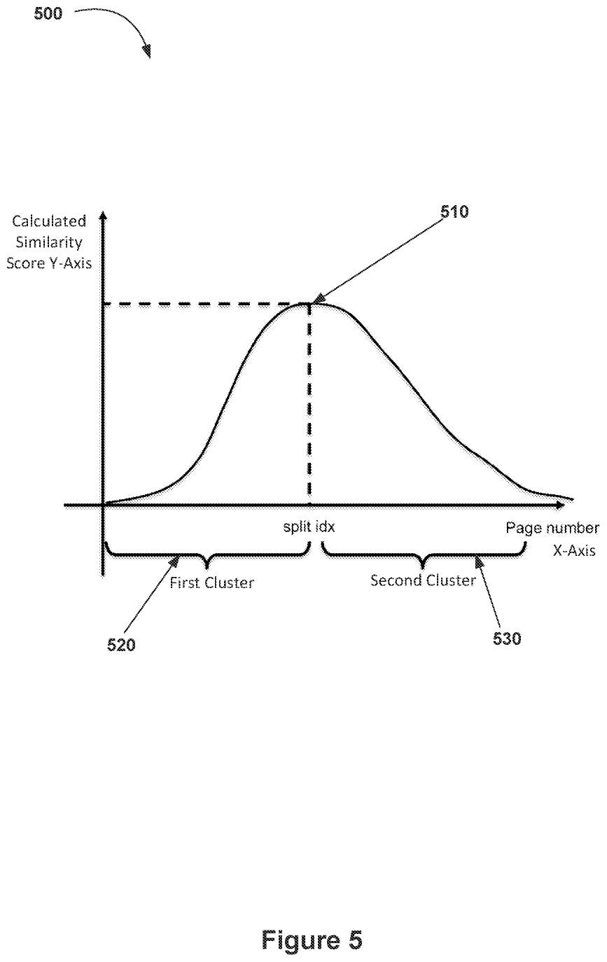

At 210, the document decomposition program 150 may calculate similarity scores by comparing the generated vector representations with a knowledgebase of document vectors. At this step, an exemplary clustering module 350 (See FIG. 3) of the document decomposition program 150 may compare each one of the generated vector representations for each respective one of the generated sub-documents from step 206 with an accessible knowledgebase of document vectors 355 (See FIG. 3) to calculate a similarity score. The knowledgebase of document vectors 355 may include a series of vector representations for historical documents or document templates for a specific domain that may be relevant for the target composite scanned document and the technological environment in which the document decomposition program 150 is being employed. The knowledgebase of document vectors 355 may be composed of standard documents and feature metadata for each of the pages therein, including features related to text content, image representation, layout representation, fonts used in the text, and any other suitable document features. The calculated similarity scores may be normalized to a value between 0 and 1, where a score of 0 represents no similarities between the vector representation of a given sub-document and the knowledgebase of document vectors, and a score of 1 would represent an exact match between the vector representation of a given sub-document and the knowledgebase of document vectors. For example, the document decomposition program 150 may calculate that the exemplary vector representation ‘V3’ for exemplary sub-document ‘SD3’ including exemplary pages ‘P1’, ‘P2’, and ‘P3’ has a similarity score of 0.8 when compared to an exemplary knowledge base of document vectors ‘KB1’. The document decomposition program 150 may calculate the similarity scores for each of the generated sub-documents. According to one embodiment, the calculated similarity scores may be tabulated or plotted sequentially based on the generated series of sub-documents. According to one embodiment, the document decomposition program 150 may identify local maximum similarity values within the calculated similarity scores based on maximum values for specific groupings of sequential pages, as may be observed at points where the plotted similarity scores reach an apex on a corresponding graph or experience a change of slope (increasing to decreasing) with respect to the plotted similarity scores. This process will be explained in greater detail in connection with the description of FIG. 5 below.

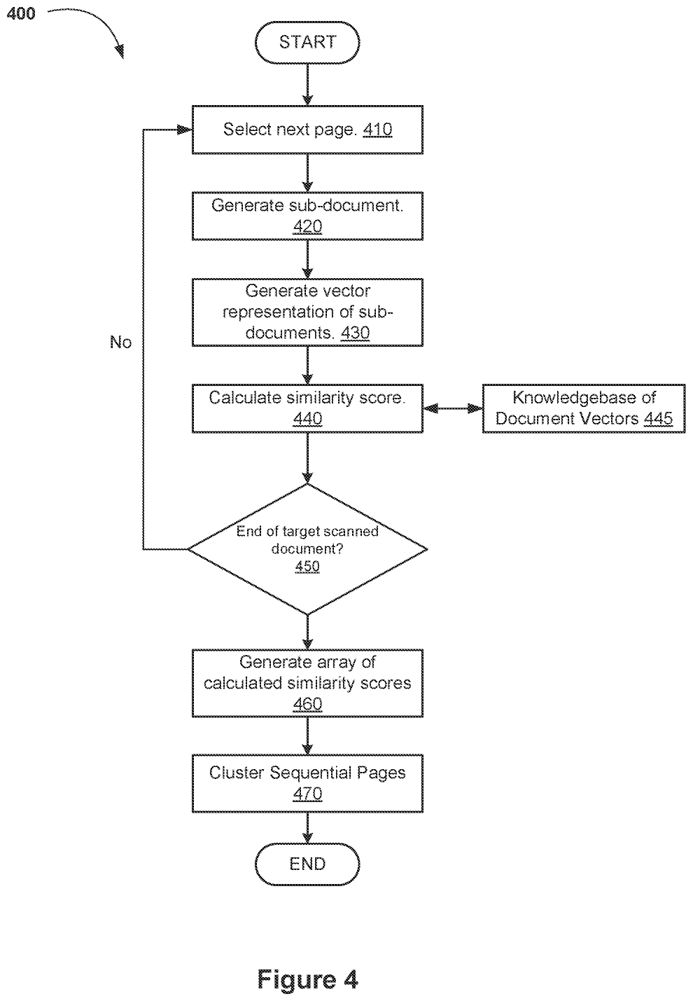

At 212, the document decomposition program 150 may cluster the sequential pages of the target composite scanned document based on the calculated similarity scores. At this step, exemplary clustering module 350 (See FIG. 3) of the document decomposition program 150 may leverage the calculated similarity scores to cluster sequential pages of the target composite scanned document which are most similar and therefore likely derived from a same individual component document. The document decomposition program 150 may leverage any suitable clustering algorithm to generate the clusters of sequential pages based on the calculated similarity scores. According to one embodiment, the document decomposition program 150 may identify local maximum similarity scores within a generated plot of the calculated similarity scores from step 210 to identify pages at which a new cluster, corresponding to a separate document or cluster of pages, should be added. The process of clustering the pages may be better understood in view of FIGS. 4 and 5 described in greater detail below.

FIG. 4 illustrates a block diagram 400 of an exemplary process of decomposing a target composite scanned document to generate clusters of sequential pages in accordance with at least one embodiment. More specifically, block diagram 400 depicts an exemplary process similar to steps 206-214 described above, performable by an exemplary document decomposition program 150 to process a target composite scanned document to generate vector representations of sub-documents that may be compared with a knowledgebase of document vectors to calculate similarity scores that may be subsequently leveraged for generating clusters of sequential pages corresponding to individual component documents of the target composite scanned document.

The exemplary process in block diagram 400 may begin with the document decomposition program 150 selecting a next page of the target document at 410. The document decomposition program 150 may then, at 420 generate a sub-document made of previous pages, and the current selected next page, as described in step 206. At 430, the document decomposition program 150 may utilize any suitable tools or techniques to generate a vector representation of the sub-document. At 440, the document decomposition program may compute a similarity score against an accessible knowledge base of document vectors 445. At 450, document decomposition program will determine if any pages remain in the document. In response to detecting additional pages, the document decomposition program 150 may return to 410 to select a next page. At 460, in response to detecting the end of the target composite scanned document has been reached, the document decomposition program 150 may generate an array, sometimes represented as a plot of points on a graph of calculated similarity scores based on the calculated similarity score and the sequential pages considered throughout this exemplary process. Thereafter at 470, the document decomposition program 150 may cluster sequential pages based on the calculated similarity scores. According to one embodiment, as discussed above, the document decomposition program 150 may generate the clusters by identifying local maximum similarity scores corresponding to pages at which a new cluster associated with an additional individual component file should be generated. Such embodiments may be better understood in view of FIG. 5, discussed in greater detail below.

FIG. 5 depicts an exemplary plot 500 of calculated similarity scores that may be leveraged to cluster sequential pages for decomposing a target composite scanned document according to at least one embodiment. As shown in exemplary plot 500, the x-axis corresponds to a number of sequential pages to which a generated sub-document extends, while the y-axis corresponds to calculated similarity scores based on comparing a vector representation of a sub-document extending to a given sequential page (plotted on the x-axis) to an accessible knowledgebase of document vectors corresponding to historically encountered document features for an associated domain. According to one embodiment, the document decomposition program 150 may identify a local maximum similarity score, shown at 510 to identify an anchor page where a new additional cluster (such as representative ‘Second Cluster 530’ in FIG. 5) should be generated, as the similarity score decreasing likely corresponds to the beginning of an additional individual component document. FIG. 5 further depicts a ‘First Cluster’ 520 starting from a first sequential page on plot 500 that extends from a first sequential page to the anchor page. The document decomposition program 150 may generate the new additional clusters starting from a next sequential page following each respective identified anchor page. For example, if for a given vector representation ‘V5’ of an exemplary sub-document ‘SD5’ extending up to an exemplary sequential page ‘P5’, the document decomposition program 150 calculates a similarity score of 0.99 (plotted as max score 510) when compared against an exemplary accessible knowledgebase of document vectors ‘KB1’, and for second vector representation ‘V6’ of an exemplary sub-document ‘SD6’ extending up to an exemplary sequential page ‘P6’, the document decomposition program 150 calculates a similarity score of 0.88 when compared against the exemplary accessible knowledgebase of document vectors ‘KB1’, then the document decomposition program 150 may identify exemplary page ‘P5’ as an anchor page serving as an end point for a first exemplary cluster ‘C1’, and generate a new additional cluster ‘C2’ of sequential pages starting at exemplary page ‘P6’, as it likely corresponds to a second individual component document. According to one embodiment, the document decomposition program 150 may identify each subsequent local maximum calculated similarity score on a given generated plot of similarity to identify additional anchor pages denoting the beginning of an additional component document and causing the document decomposition program 150 to generate an additional cluster of sequential pages. Thus, the document decomposition program 150 may calculate similarity scores by comparing respective vector representations of the generated sub-documents to an accessible knowledgebase of document vectors, and subsequently cluster sequential pages of the target composite scanned document based on the calculated similarity scores, as described above in connection with steps 206-212.

At 214, the document decomposition program 150 may then output separate files including the clustered sequential pages. For example, if the document decomposition program 150 generated, for a target composite scanned document, a first cluster ‘C’ including sequential pages ‘P1-P6’, a second cluster ‘C2’ including sequential pages ‘P7-P10’, and a third cluster ‘C3’ including sequential pages ‘P11-P15’, then at 214, the document decomposition program 150 may output separate files ‘F1’, ‘F2’, and ‘F3’ respectively as individual component documents, where each of the respective files includes the sequential pages from the respective corresponding clusters ‘C1’, ‘C2’ and ‘C3’. Thus, the target composite scanned document has been decomposed into three separate files including sequential pages from the respective generated clusters.

In some alternative embodiments, the document decomposition program 150 may instead compare vector representations of respective sequential pages of the target composite scanned document to calculate similarity scores, rather than generated sub-documents. In such embodiments, for example, the document decomposition program 150 may calculate a similarity score for adjacent exemplary pages ‘P1’ and ‘P2’ by comparing generated final feature vectors ‘V1’ and ‘V2’ corresponding to the extracted series of document features for the respective pages. According to one embodiment, the calculated similarity score may be normalized and represented as a number between 0 and 1, where a score of 1 represents a relatively high similarity between two adjacent pages based on document features, and scores closer to 0 represent low relative similarity between adjacent pages based on document features. For example, if exemplary pages ‘P1’ and ‘P2’ have many overlapping features, then the document decomposition program 150 may, by considering final feature vectors ‘V1’ and ‘V2’, calculate a similarity score of 0.9 between adjacent exemplary pages ‘P1’ and P2′. The document decomposition program 150 may then generate clusters of similar pages by comparing the calculated similarity scores between adjacent pages to a predetermined similarity threshold value. The document decomposition program 150 may cluster together adjacent pages associated with similarity scores above the predetermined similarity threshold value and start separate clusters when two adjacent pages fall below the predetermined similarity threshold value. For example, in an exemplary embodiment the document decomposition program 150 may calculate a similarity score for exemplary page ‘P1’ and ‘P2’ by comparing corresponding exemplary final feature vectors ‘V1’ and ‘V2’ to obtain a similarity score of 0.95. In this example, if the document decomposition program 150 is configured to consider a predetermined similarity threshold value of 0.9 for similarity between adjacent pages, then a clustering module 350 (see FIG. 3) of the document decomposition program 150 may cluster together exemplary pages ‘P1’ and ‘P2’ into an exemplary cluster of pages ‘C1’. Next, the document decomposition program 150 may consider a next adjacent sequential page ‘P3’ and its associated exemplary final feature vector ‘V3’ and compare it to exemplary final feature vector ‘V2’ to calculate a similarity score of 0.6 between pages ‘P2’ and ‘P3’. In response to the calculated similarity score between exemplary pages ‘P2’ and ‘P3’ being below the predetermined similarity threshold value of 0.9, clustering module 350 of the document decomposition program 150 may generate an exemplary separate cluster of pages ‘C2’ to include exemplary page ‘P3’. The document decomposition program 150 may then continue to compare sequential adjacent pages within the target composite scanned document until it has processed each page of the target composite scanned document. Once the document decomposition program 150 has considered each of the sequential pages in the target composite scanned document and generated the respective clusters of pages, then an exemplary output generation module 360 (see FIG. 3) of the document decomposition program 150 may generate and output separate files for each of the clusters of respective pages.

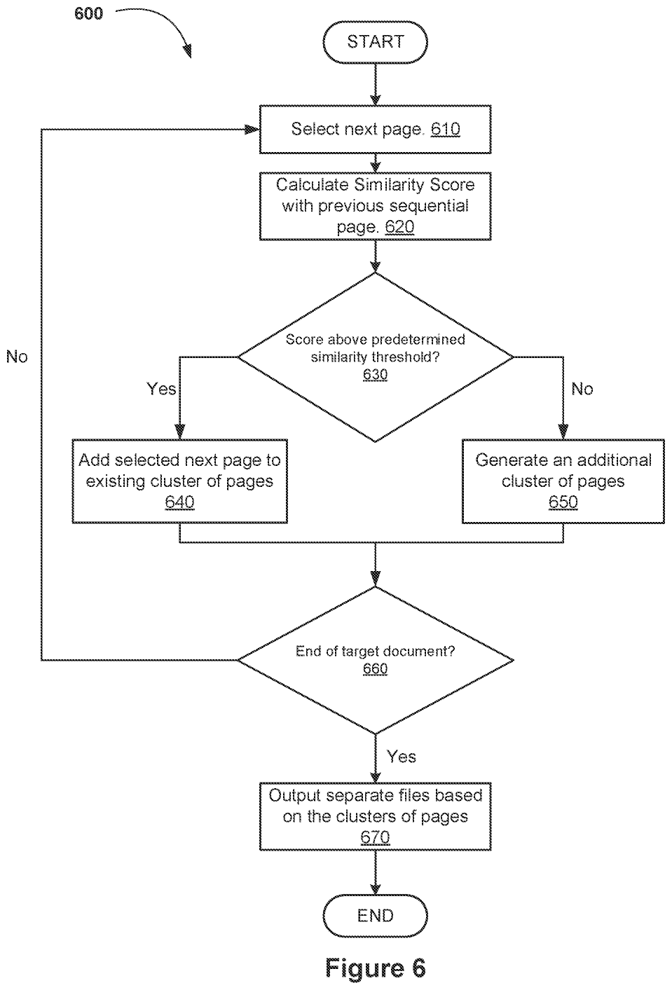

This alternative embodiment is further depicted in FIG. 6. FIG. 6 illustrates a block diagram of an exemplary process 600 of generating groups of pages by leveraging similarity scores between vector representations of adjacent sequential pages from a target composite scanned document. In FIG. 6, it is assumed that the document decomposition program 150 has already extracted the series of document features for each sequential page of a target composite scanned document and generated final feature vectors corresponding to each of the sequential pages (by extracting the series of document features from sequential pages as described above at step 204 and leveraging vector generation module 340 to generate vector representations of the sequential pages). The document decomposition program 150 may leverage an exemplary clustering module 350 (See FIG. 3) to begin performing exemplary process 600 by first selecting a next page of a target composite scanned document at 610. The document decomposition program 150 may then, at 620, calculate similarity scores for the selected page, represented by ‘pi’ and a previous sequential page represented by ‘pi−1’ by comparing corresponding final feature vectors for each of the respective pages. At 630, document decomposition program may determine if the calculated similarity score from 620 is above or below a predetermined similarity threshold value. At 640, the document decomposition program 150 may, in response to the calculated similarity score being above the predetermined similarity threshold value, add the selected page to an existing cluster of pages. At 650, the document decomposition program 150 may, in response to the calculated similarity score being below the predetermined similarity threshold value, generate an additional cluster (group) of pages group for the selected page to be added to. At 660, the document decomposition program 150 may determine if the end of the target composite scanned document has been reached. If the end of the target composite scanned document has been reached, the document decomposition program 150 may return to 610 to select a next page and repeat the process. If the end of the target scanned document has been reached, the document decomposition program 150 may output separate files at 670 based on the previously generated groups of pages.

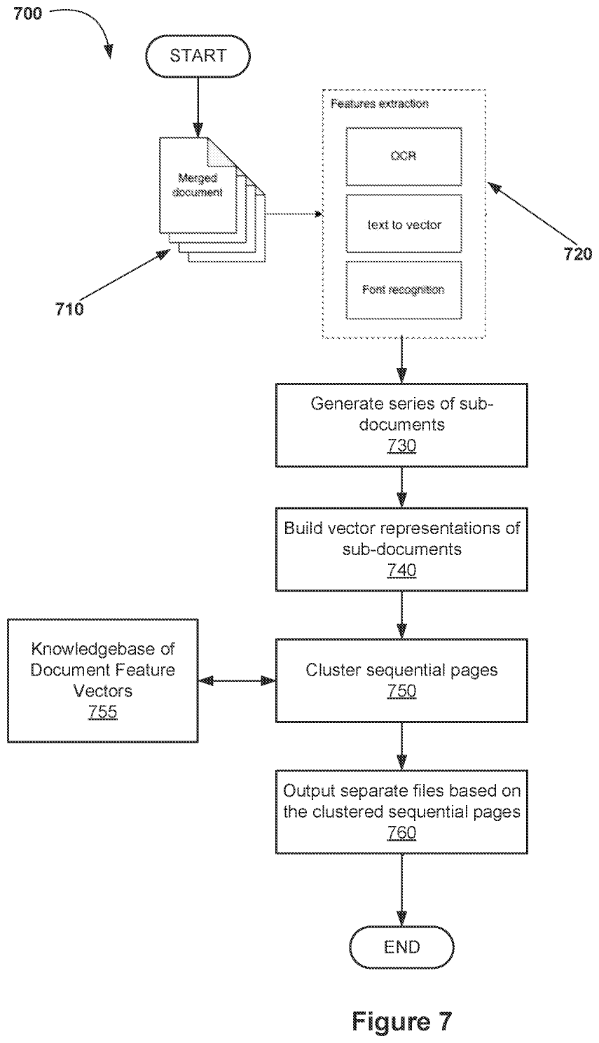

FIG. 7 illustrates a block diagram of an exemplary process 700 of decomposing composite scanned documents according to at least one embodiment. Process 700, performable by an exemplary document decomposition program 150, may be better understood in view of the description of illustrative process 200 of FIG. 2. In FIG. 7, an exemplary composite document detection module 310 (See FIG. 3) of the document decomposition program 150 may receive a target composite scanned document at 510 represented as a ‘merged document’ that is made up of individual component documents that have been merged. At 720, an exemplary feature extraction module 320 (See FIG. 3) of the document decomposition program 150 may extract features from a series of sequential pages using suitable natural language processing and document analysis tools and techniques. At 730 an exemplary sub-document generation module 330 (See FIG. 3) of the document decomposition program 150 may iteratively generate a series of sub-documents as described above in connection with step 206. At 740 an exemplary vector generation module 340 (See FIG. 3) of the document decomposition program 150 may build vector representations of the generated sub-documents as described above. At 750, an exemplary clustering module 350 (See FIG. 3) of the document decomposition program 150 may cluster sequential pages based on calculate similarity scores, the calculated similarity scores determined by comparing the vector representations from 740 to an accessible knowledgebase of document feature vectors 755. Thereafter, at 760, an exemplary output generation module 360 (See FIG. 3) of the document decomposition program 150 may generate and output separate files including the respective sequential pages included within each of the clusters generated at 750.

It may be appreciated that the document decomposition program 150 has thus provided for improved decomposing of composite scanned documents. Described embodiments extract document features from sequential pages in a target composite scanned document to generate vector representations of a series of sub-documents including increasing numbers of sequential pages from the target composite scanned document. Described embodiments may then compare the vector representations of the respective sub-documents to a knowledge base of document vectors for an applicable domain with which the target composite scanned document is associated to calculate similarity scores. Described embodiments may then cluster the sequential pages based on the calculated similarity scores, and output separate files containing the clustered sequential pages. Thus, described embodiments allow for a target composite scanned document to be decomposed and output as one or more separate files that are likely to correspond to the individual component documents from which the target composite scanned document was derived. Described embodiments may identify anchor pages corresponding to local maximum values for the calculated similarity scores to determine which of the sequential pages may correspond to a new cluster of pages corresponding to a separate component document.

Described embodiments thus provide automated methods for detecting and decomposing merged documents that may be leveraged as an effective preprocessing step for enabling and facilitating automatic analyses would be advantageous for a variety of business processes.

It may be appreciated that FIGS. 2-7 provide only illustrations of an exemplary implementation and do not imply any limitations with regard to how different embodiments may be implemented. Many modifications to the depicted environments may be made based on design and implementation requirements.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-based method of decomposing a composite scanned document, the method comprising:
detecting a target composite scanned document;
extracting, for sequential pages of the target composite scanned document, a series of document features;
iteratively generating a series of sub-documents by iteratively adding a next page from the target composite scanned document to a series of one or more pages preceding the added next page;
generating vector representations for each of the iteratively generated series of sub-documents, wherein each of the generated vector representations is based on the extracted series of document features of the sequential pages contained in a corresponding respective sub-document;
calculating similarity scores by comparing the generated vector representations with a knowledgebase of document vectors;
clustering the sequential pages of the target composite scanned document based on the calculated similarity scores; and
outputting separate files including the clustered sequential pages.

2. The computer-based method of claim 1, wherein the extracted series of document features comprises one or more of page structure features, page textual features, and page layout features.

3. The computer-based method of claim 1, further comprising:
generating a plot of the calculated similarity scores; and
identifying anchor pages corresponding to local maximum similarity scores in the generated plot.

4. The computer-based method of claim 3, wherein clustering the sequential pages of the target composite scanned document based on the calculated similarity scores further comprises:
generating additional clusters of sequential pages, the additional clusters of sequential pages following each respective one of the identified anchor pages.

5. The computer-based method of claim 2, wherein the target composite scanned document has been scanned using optical character recognition, and the page textual features are extracted using natural language processing techniques.

6. The computer-based method of claim 2, wherein the page layout features are encoded into concatenated vectors using text-to-vector models.

7. The computer-based method of claim 2, wherein the extracted series of document features further include fonts used.

8. A computer system, the computer system comprising:
one or more processors, one or more computer-readable memories, one or more computer-readable tangible storage medium, and program instructions stored on at least one of the one or more computer-readable tangible storage medium for execution by at least one of the one or more processors via at least one of the one or more computer-readable memories, wherein the computer system is capable of performing a method comprising:
detecting a target composite scanned document;
extracting, for sequential pages of the target composite scanned document, a series of document features;
iteratively generating a series of sub-documents by iteratively adding a next page from the target composite scanned document to a series of one or more pages preceding the added next page;
generating vector representations for each of the iteratively generated series of sub-documents, wherein each of the generated vector representations is based on the extracted series of document features of the sequential pages contained in a corresponding respective sub-document;
calculating similarity scores by comparing the generated vector representations with a knowledgebase of document vectors;
clustering the sequential pages of the target composite scanned document based on the calculated similarity scores; and
outputting separate files including the clustered sequential pages.

9. The computer system of claim 8, wherein the extracted series of document features comprises one or more of page structure features, page textual features, and page layout features.

10. The computer system of claim 8, further comprising:
generating a plot of the calculated similarity scores; and
identifying anchor pages corresponding to local maximum similarity scores in the generated plot.

11. The computer system of claim 10, wherein clustering the sequential pages of the target composite scanned document based on the calculated similarity scores further comprises:
generating additional clusters of sequential pages, the additional clusters of sequential pages following each respective one of the identified anchor pages.

12. The computer system of claim 9, wherein the target composite scanned document has been scanned using optical character recognition, and the page textual features are extracted using natural language processing techniques.

13. The computer system of claim 9, wherein the page layout features are encoded into concatenated vectors using text-to-vector models.

14. The computer system of claim 9, wherein the extracted series of document features further include fonts used.

15. A computer program product, the computer program product comprising:
one or more computer-readable tangible storage medium and program instructions stored on at least one of the one or more computer-readable tangible storage medium, the program instructions executable by a processor capable of performing a method, the method comprising:
extracting, for sequential pages of the target composite scanned document, a series of document features;
iteratively generating a series of sub-documents by iteratively adding a next page from the target composite scanned document to a series of one or more pages preceding the added next page;
generating vector representations for each of the iteratively generated series of sub-documents, wherein each of the generated vector representations is based on the extracted series of document features of the sequential pages contained in a corresponding respective sub-document;
calculating similarity scores by comparing the generated vector representations with a knowledgebase of document vectors;
clustering the sequential pages of the target composite scanned document based on the calculated similarity scores; and
outputting separate files including the clustered sequential pages.

16. The computer program product of claim 15, wherein the extracted series of document features comprises one or more of page structure features, page textual features, and page layout features.

17. The computer program product of claim 15, further comprising:
generating a plot of the calculated similarity scores; and
identifying anchor pages corresponding to local maximum similarity scores in the generated plot.

18. The computer program product of claim 17, wherein clustering the sequential pages of the target composite scanned document based on the calculated similarity scores further comprises:
generating additional clusters of sequential pages, the additional clusters of sequential pages following each respective one of the identified anchor pages.

19. The computer program product of claim 16, wherein the target composite scanned document has been scanned using optical character recognition, and the page textual features are extracted using natural language processing techniques.

20. The computer program product of claim 16, wherein the page layout features are encoded into concatenated vectors using text-to-vector models.
